(19) United States
(12) Patent Application Publication
(10) Pub. No.: US 2006/0144166 A1
(43) Pub. Date: Jul. 6, 2006

(54) Inductive torque sensor

(76) Inventors: Stefan Ruehl, Luenen (DE); Klaus Fallak, Werne (DE)

Correspondence Address: MILDE & HOFFBERG, LLP, 10 BANK STREET, SUITE 460, WHITE PLAINS, NY, 10606, US

(21) Appl. No.: 11/283,352

(22) Filed: Nov. 18, 2005

(30) Foreign Application Priority Data
Nov. 19, 2004 (DE) 10 2004 056 049.8

(51) Int. Cl. G01L 3/10

(52) U.S. Cl. 73/862.331

(57) ABSTRACT

In an inductive torque sensor, two rotatable rotor elements (114a, 114b) are mounted axially and adjacent at a distance from the shaft components (112a, 112b) of a shaft (112). An inductive coupling element (18) is mounted about the circumference of each of the rotor elements (114a, 114b). An inductive circuit (30) with at least two inductors (34a, 34b, 34) on a stator element (120) extends along a sensor area so that, when the rotor elements (114a, 114b) rotate, the inductive coupling elements (18) are displaced along the inductors (34, 34a, 34b), causing a position-dependent inductive coupling between the inductors. Cost-effective manufacture is possible if the inductive circuit (30) is so mounted that with the inductive coupling element (18) it covers both rotor elements (114a, 114b). The inductive coupling elements (18) thus possess distinguishable inductive coupling characteristics.

The invention relates to a torque sensor and a rotation sensor.

The term “rotation sensor” is understood to mean a sensor that may determine the relative position of two elements that may rotate with respect to each other, namely of a stator and of a rotor. Rotation sensors are used in various realms of technology to determine rotational positions for various control and regulation applications.

The term “torque sensor” is understood to mean a sensor that determines the torque in a shaft. Torque sensors are also used in a large number of control and regulation applications. A special application of torque sensors is the determination of torque of a steering shaft to control a servo-support system (power steering).

Rotation sensors and torque sensors are similar in function and structure in that for torque sensors, coupled shaft components may be rotated with respect to each other under the influence of the torque to be determined, and the rotation thus caused may be measured by rotation sensors. DE-A-197 45 823 describes a device to measure torque and rotation angle of a shaft. Disk elements are mounted at two axially displaced positions of the shaft. Their rotational position may be determined optically, electromagnetically, capacitively, or mechanically. For this, the shaft components may be connected together by means of a torsion bar that includes a specific torsion parameter so that the shaft components rotate with respect to each other by a certain angle under influence of a specific torque transferred from the shaft. The corresponding relative rotation of the disk elements is determined, thus determining the torque.

WO-A-98/48244 shows a rotation sensor and torque sensor in which determination of the angular position results by means of a Hall-effect sensor. Magnets are positioned on a shaft while air gaps are formed in a stator element between flux-conductance elements. The magnetic flux in the air gaps is measured using Hall IC's, and the rotational position of the magnet element is thus determined. The torsion and thus the transferred torque may be calculated from each rotational-position value.

DE-A-42 31 646 describes a measurement configuration to determine the torsion and the torque of a shaft. Ring-shaped bodies of slightly magnetic material are positioned axially separated that rotate with respect to one another under torsion. These bodies include a rotation-symmetric assembly with projections and recesses. Several inductors are provided in a stator component by means of which an alternating electromagnetic field is created. By matching the projections to one another, or by torsion adjustment of the projections to one another, measurable alteration to the inductance of the magnetic circuit results from which a measurement value for the torsion may be determined.

DE-A-4232993 presents a device to measure torsion and/or the relative angular displacement of a shaft assembly. In the shaft configuration to be measured, two inductor assemblies with air gaps are mounted as a rotor. An inductor ring assembly is provided as a stator. The inductor assemblies involve relatively complex spatial requirements in which the ring elements are wrapped with ferrite-filled material with inductor wire. The torsion of the shaft configuration results from adjusting the inductor assemblies with respect to each other that leads to increase or decrease of an electrical field within the inductor assemblies when current flows through them. These electrical signals are transferred to the inductor-ring assembly of the stator, and the resulting measurement curves are evaluated.

These various configurations of rotation sensors and torque sensors have the disadvantage that all rotor and stator components must be reproduced and installed with a very high degree of precision. For magnetic sensors, the width of the air gap is a determining factor, so that an exact value must be maintained. Moreover, further technical manufacturing requirements such as precise manufacture of complexly shaped metal bodies and wound inductors, resulting in the high overall costs for conventional sensors. Manufacturing costs are particularly high for torque sensors, since their complex design results in a cost that is approximately double that of rotation sensors.

It is the principal object of the present invention to provide a rotation sensor and a torque sensor for which cost-effective manufacture is possible.

This object is achieved by an inductive torque sensor as in Claim 1, and by an inductive rotation sensor as in Claim 15. The Dependent Claims are related to advantageous preferred embodiments of the invention.

The inductive sensors according to the invention each contain at least one stator element and at least one rotor element that is rotatable about a rotation axis with respect to the stator element.

For these sensors, an inductive circuit with at least two inductors is provided that extend along a sensor area. An inductive coupling element is provided on the rotor element. When the elements rotate with respect to each other, the inductive coupling element is displaced along the inductors and causes position-dependent inductive coupling between the inductors. This coupling may be easily measured in that an exciter signal is created within one of the inductors and the receiver signal is evaluated from a second inductor. Since the inductive coupling element requires no connections, its structure is particularly simple since no inconvenient contacts, especially friction-contact rings, are required.

Based on the invention, the torque sensor includes at least two rotatable rotor elements mounted axially on a common axis of shaft components of a shaft so that they may rotate with respect to the stator element.

An inductive coupling element is provided at each sensor area of the rotor elements. For this, the inductive coupling elements of the two rotor elements possess different inductive coupling characteristics. If the coupling elements are configured as a resonance circuit, then they preferably possess different resonance frequencies. For this, the elements preferably possess identical inductive inductor designs, but are configured with different capacitors.

The inductive circuit based on the invention is so constructed that it overlaps the inductive coupling elements of both rotor elements.

The inductive torque sensor based on the invention is thereby of very simple design. The absolute and relative rotational positions of both rotor elements may be determined. Thus, manufacturing expense and the number of parts required are considerably reduced, and the sensor may be manufactured at extreme low cost.

It is possible for the inductive circuit to possess an inductor structure with at least one transmitter and one receiver coil whose width covers both rotor elements. Based on an expansion, it is provided that two separate, ring-shaped inductor structures are formed, each with at least one transmitter and one receiver coil. Thus, an inductor structure is assigned to each rotor. Each inductor structure for this is preferably connected to a separate evaluation circuit. The positions of both rotors may thus be determined simultaneously. The expense remains small, however, since only one stator element is required.

An evaluation circuit is preferably connected to the sensor with two rotor elements that determines the rotational positions of both the first and the second rotor elements by means of an exciter signal in one of the inductors and the processing of a receiver signal from at least one additional coil.

For delivery of a sensor signal for the torque, the two rotor elements are preferably mounted on flying shaft components that are elastic with respect to each other. A value for the torque may be determined from the differentials of the rotational positions of the rotor elements.

Based on a separate aspect of the invention, the inductive circuit includes a flexible carrier material. The inductors are formed as conductors at or on this carrier material, e.g., as conductor paths that extend at or on this carrier material or as conducting wires that are connected with the carrier material or embedded in it. The flexible carrier material, which is preferably plastic, extends in a bent manner along the sensor area. The carrier material is preferably flat, e.g., in the shape of a flat conductor strip. Such a flat carrier material is preferably bent across the short dimension of the surface. The carrier material may consist of a material that is sufficiently thin to be bent at a radius of 10 cm or less, preferably 5 cm or less. The flexibility may also be achieved in other ways, e.g., by means of a segmented structure with bend or crease lines.

Such a sensor may be used in order to determine the rotational position of the first and the second elements in that the position-dependent inductive coupling between the inductors is evaluated. As explained, the sensor may also be used as a torsion or torque sensor, whereby the relative rotational positions of two rotor elements and one stator are determined and correspondingly evaluated. With suitable evaluation, the sensor delivers both the absolute rotational position of the elements (and thereby derivative values such as rotational speed or number of rotations using suitable processing) and the relative rotational position of two elements with respect to each other with high precision.

The inductive coupling element may also possess a conductor structure based on a flexible carrier material.

The sensor based on the invention is therefore of particularly simple design, and is therefore low-cost.

The inductive circuit and/or the inductive coupling element on a flexible carrier material may easily be manufactured particularly cheaply, e.g., with the help of a printing technique or conventional circuit-board etching techniques. The flat inductors are considerably simpler to manufacture than wound inductors, especially if the windings must be positioned about the shaft. All carrier components may preferably be manufactured of plastic, so that they may be produced in large quantities at low cost. Using suitable evaluation, the precise positioning of the two elements rotating with respect to each other is not critical, so that exact determination of measurement values is possible even under conditions of higher manufacturing tolerances.

The inductive circuit and/or the inductive coupling element may be manufactured in flat condition of the carrier material, and the carrier material in flexible condition may be so mounted on the second element that it is bent and extends along the sensor areas. Thus, in an especially cost-effective manner, the necessary spatial structure (bent extension along the sensor area) may be created, whereby, for example, conventional conductor-strip techniques may be used to create inductor structures on the flat carrier material. It must be mentioned here that the flexible carrier material need not remain flexible during subsequent operation of the sensor, but rather it is also possible that the carrier material be attached in its bent shape, e.g., hardened. It is even possible that an essentially stiff carrier material is made flexible, e.g., by heat effect, only for the mounting of the second element. It is particularly preferable that the flexible carrier material be embedded in plastic using an injection-molding process, and is thus attached to the stator or rotor.

The flexible carrier material of the inductive circuit and/or of the coupling elements is preferably essentially bent into a ring-shape, or is at least partially ring-shaped. For example, it may enclose at least a quarter- or half-circle. It is particularly advantageous for it essentially to enclose the first element. Here, ‘essentially’ is understood to mean that preferably an entire circle of 360° is covered, but areas for electrical components, for example, may remain free.

For good measurement-value determination, the rotor and stator elements should be at least partially be covered, i.e., that the inductive coupling element should move within the range of the inductive coupling element. It is preferable that the sensor area of the stator element be positioned radially adjacent to the inductive coupling element.

The stator element is preferably a fixed ring element that is mounted at least partially radially about the rotor element, and preferably essentially surrounds it. The rotor element is mounted to be rotatable, preferably on a shaft. The sensor area of the rotor element is preferably at least partially formed as a cylindrical surface. The ring element preferably includes a receiver area at which the flexible carrier material is applied.

Based on an expansion, an evaluation circuit is connected to the inductive circuit. This circuit may be provided on the stator element. The evaluation circuit is preferably mounted directly on the flexible carrier material or connected directly with it. The evaluation circuit is preferably connected via a plug connector on the stator element. The necessary operating voltage may be delivered by means of this, while on the other hand the sensor signal may be queried in digital form (e.g., as PWM signal or digital bus signal) or in analog form (e.g., as voltage signal), e.g., for processing within a control unit.

The evaluation circuit creates an exciter signal in one of the inductors and evaluates a receiver signal that is created by over-coupling from the first coil into an additional coil. By means of the position-dependent over-coupling via the inductive coupling element, its position and thus the rotational position may be determined. Various function modes are known for such inductive sensors whereby preferably either several exciter coils or several receiver coils are used. A sensor as described by WO-A-03/038379 is especially preferred.

For this, the inductive coupling element is configured as a resonance circuit with a capacitor and with an inductor. When the exciter coils operate with an alternating-current signal in the realm of the resonance frequency, the resonance overlap creates a relatively strong output signal at the receiver coil so that even enlarged separations between the inductive coupling element and the inductive circuit deliver signals that are still useable.

The first and second elements preferably are essentially surrounded by a housing and thus protected from external influence. The housing is preferably connected with the second element or even formed with it as one piece.

The inductive coupling element may be configured as desired as long as it serves as an inductive over-coupling between exciter coil and receiver coil. This includes, for example, a ferrite element or a conductor layer.

The inductive coupling element is preferably, however, a resonance circuit with a capacitor and with an inductor, as described in WO-A-03/038379.

The independent solutions as in Patent Claims 1 and 15 are, of course, freely combinable. Thus, it is preferred for the inductive torque sensor to construct the inductive circuit of flexible carrier material. It is also particularly preferred to use resonance circuits with different resonance frequencies as inductive coupling elements.

In the following, preferred embodiments of the invention will be described in greater detail using the Illustrations, which show:

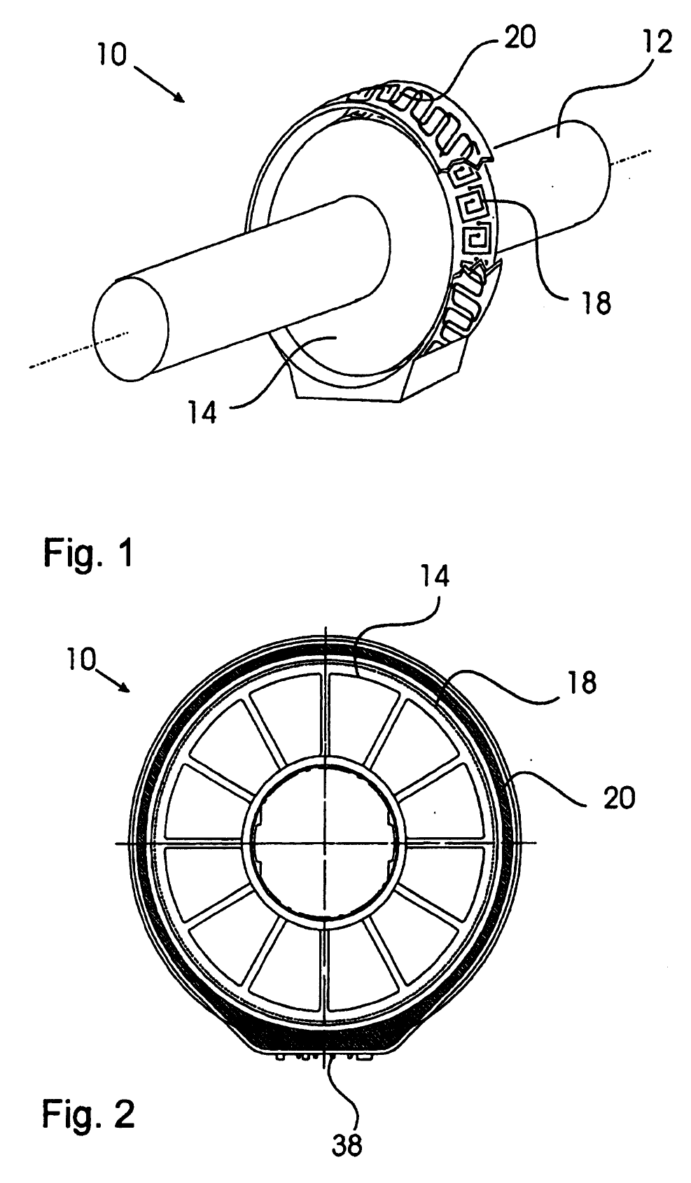

FIG. 1 a partial cutaway perspective view of a first preferred embodiment of a sensor;

FIG. 2 cross-sectional view of the sensor as in FIG. 1;

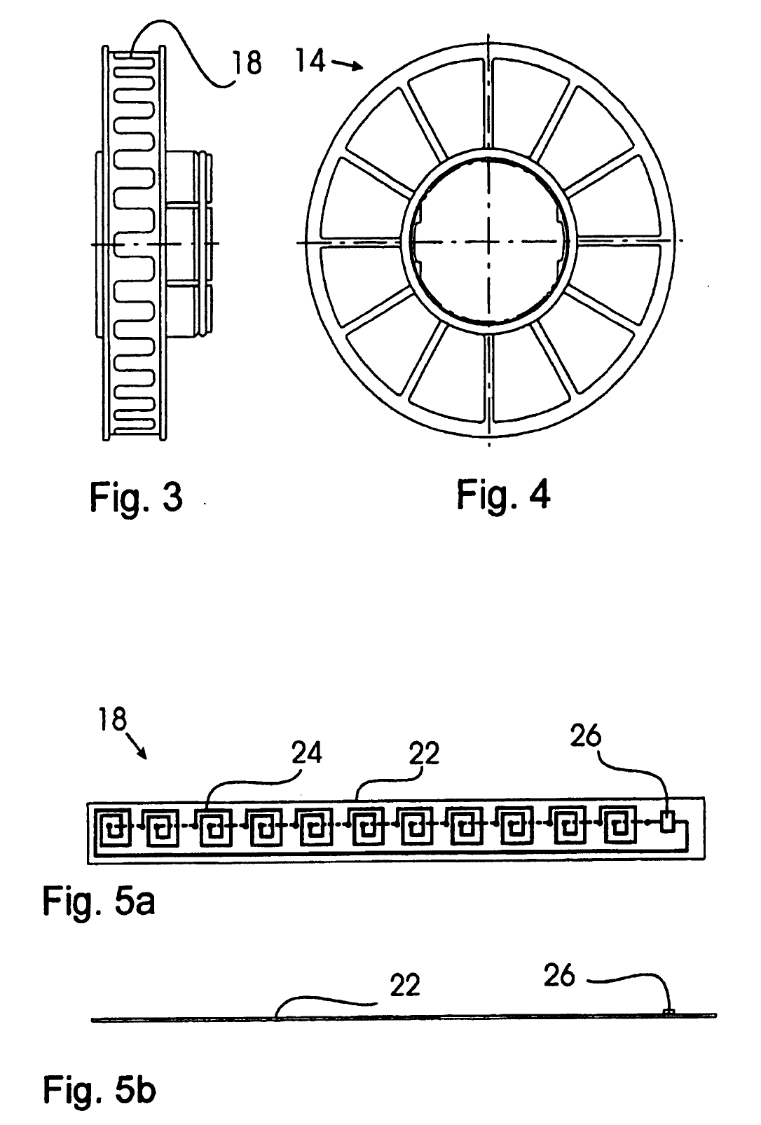

FIG. 3 lateral view of a rotor element of the sensor as in FIG. 1;

FIG. 4 frontal view of the rotor element as in FIG. 3;

FIG. 5a top view of an inductive coupling element of the rotor element as in FIG. 3, 4;

FIG. 5b lateral view of the inductive coupling element as in FIG. 5a;

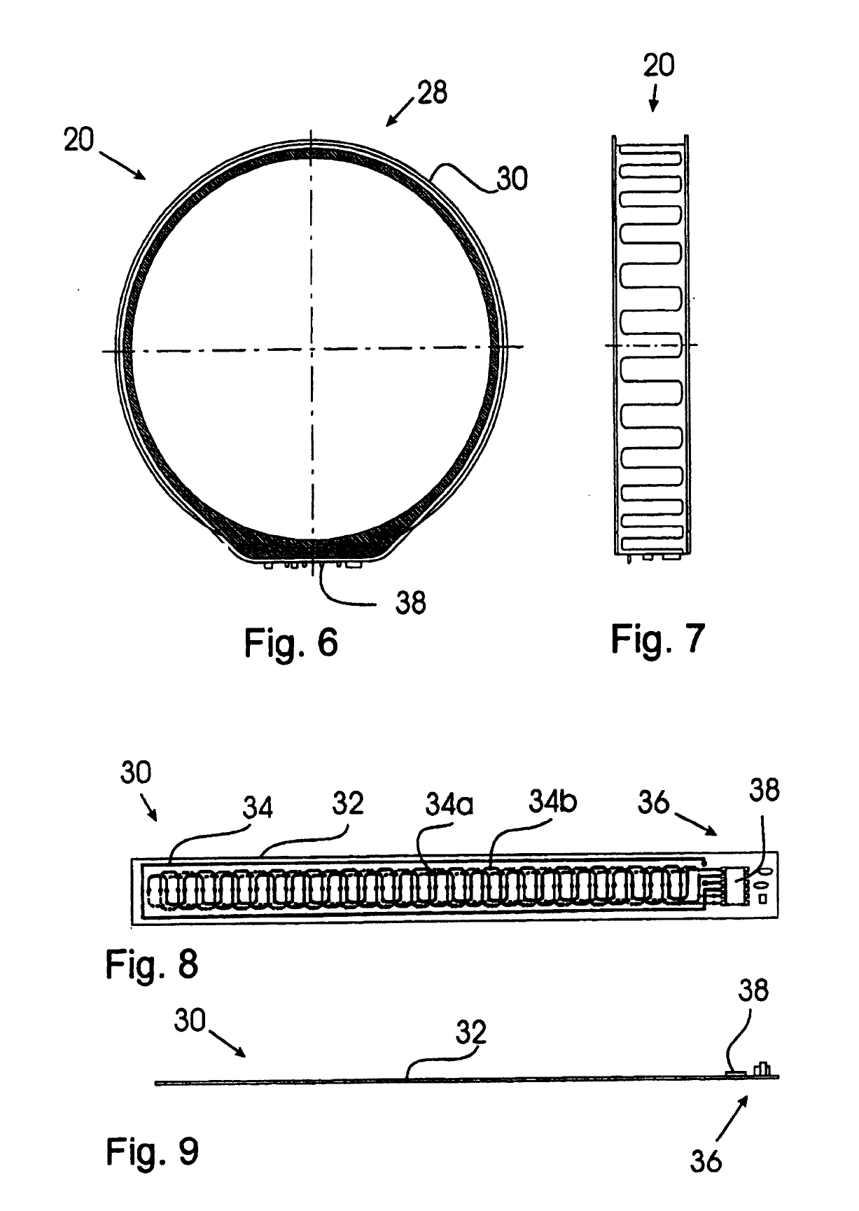

FIG. 6 frontal view of a stator element of the sensor as in FIG. 1;

FIG. 7 lateral view of the stator element as in FIG. 6;

FIG. 8 top view of an inductive circuit of the stator element as in FIG. 7;

FIG. 9 lateral view of the inductive circuit as in FIG. 8;

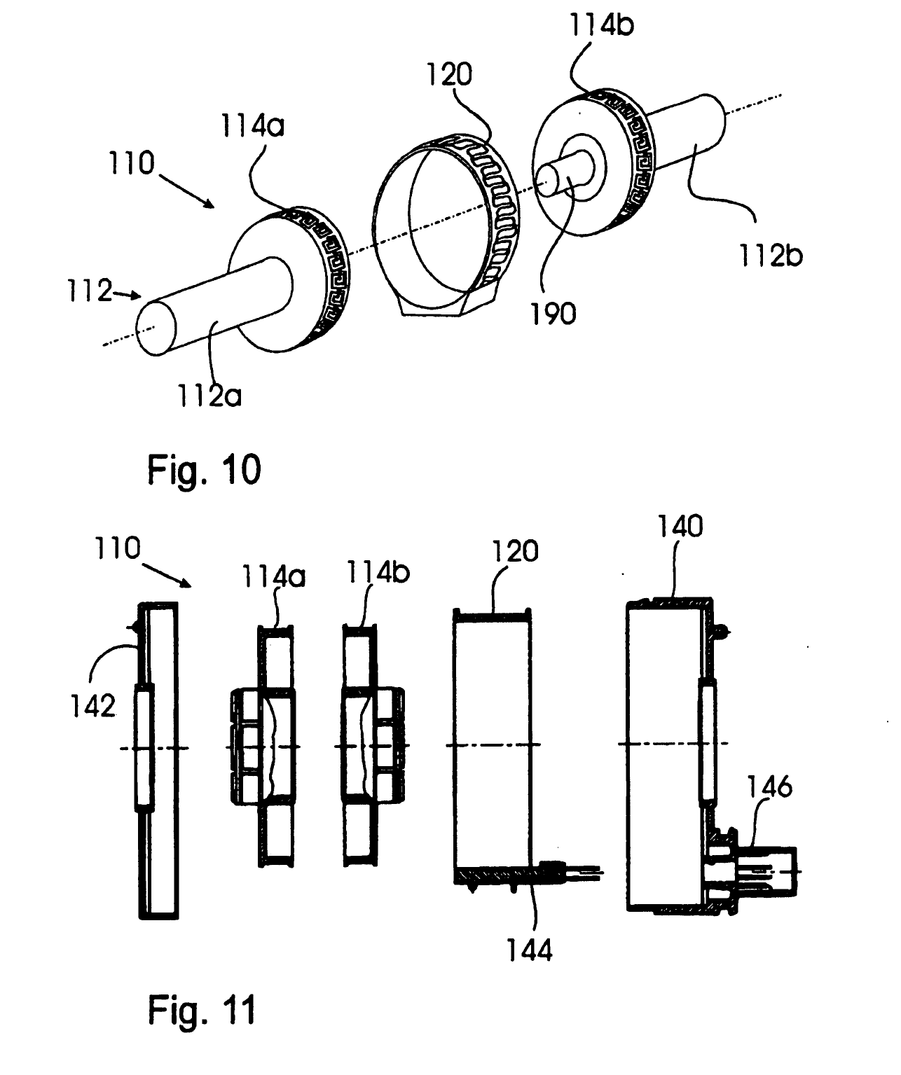

FIG. 10 perspective exploded view of a second preferred embodiment of a sensor;

FIG. 11 longitudinal exploded cutaway view of elements of the sensor as in FIG. 10;

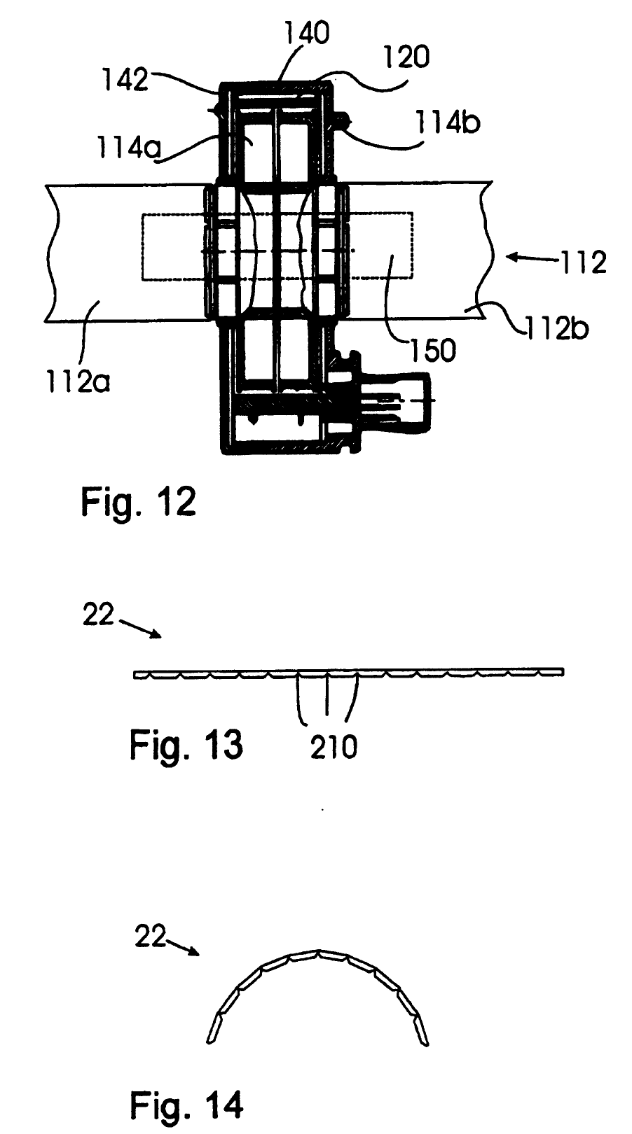

FIG. 12 lateral view longitudinal cutaway view of the sensor as in FIG. 10.

FIG. 13 lateral view of an alternative flexible carrier strip in flat form;

FIG. 14 lateral view of the alternative flexible carrier strip as in FIG. 13 in a bent shape;

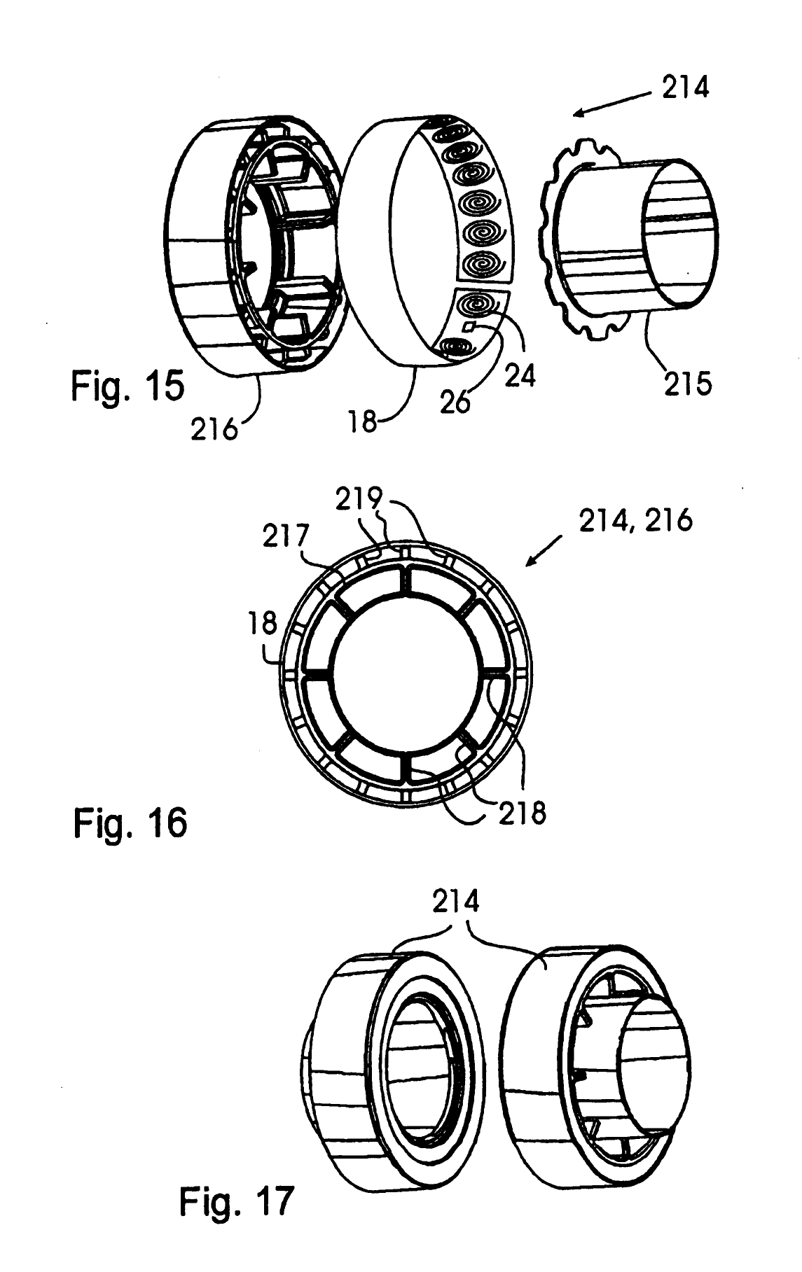

FIG. 15 exploded perspective view of a rotor element according to a third preferred embodiment;

FIG. 16 cross-sectional view of the rotor element as in FIG. 15;

FIG. 17 a perspective view of two rotor elements of the type in FIG. 15, FIG. 16;

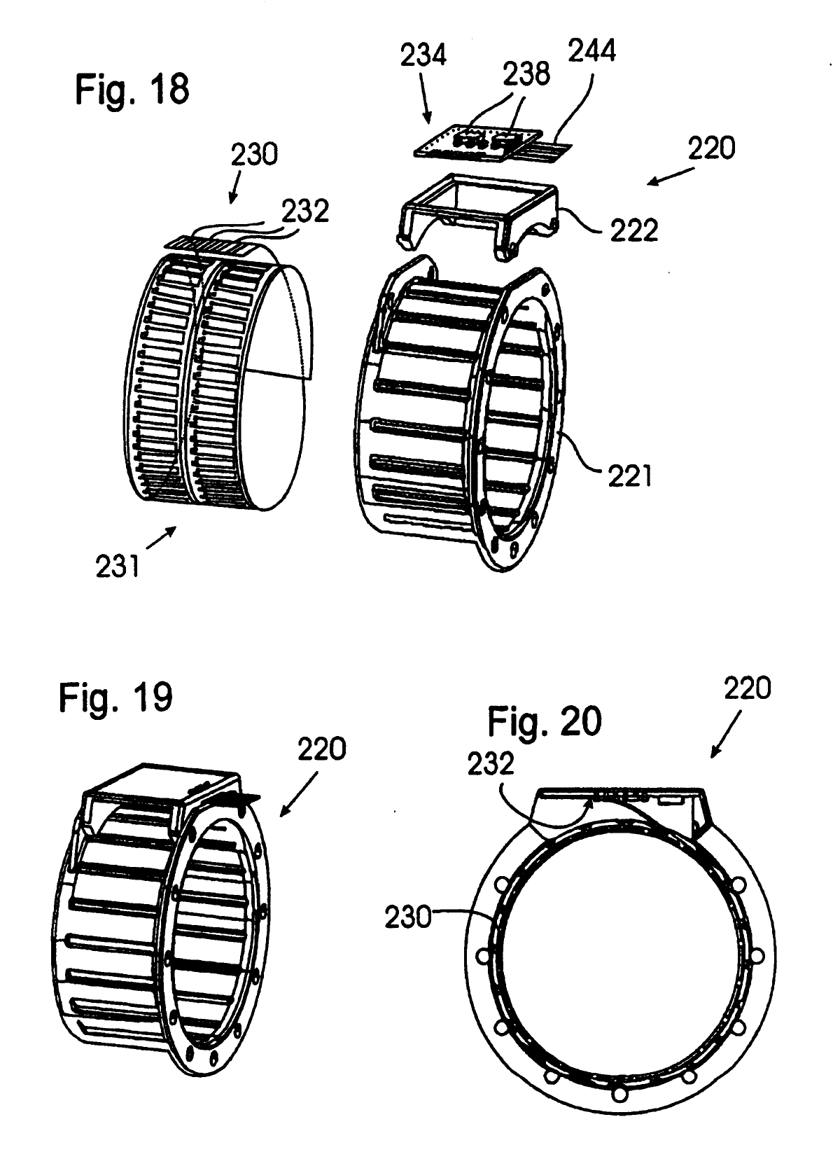

FIG. 18 an exploded perspective view of a stator element according to a third preferred embodiment;

FIG. 19 a perspective view of the stator element as in FIG. 18;

FIG. 20 cross-sectional view of the stator element as in FIG. 18, FIG. 19;

FIG. 21 a exploded perspective view of a torque sensor according to a third preferred embodiment;

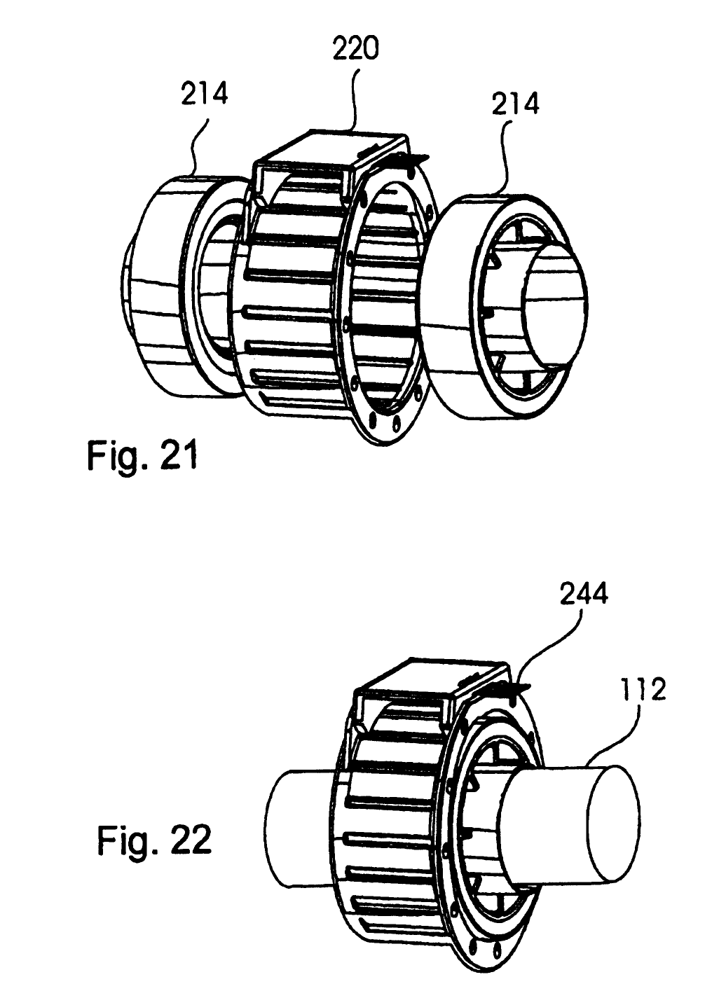

FIG. 22 a perspective view of the torque sensor as in FIG. 21.

FIG. 1 shows a rotation sensor corresponding to a first preferred embodiment. A rotor element 14 is mounted on a shaft 12 that rotates with the shaft 12. The rotor element 14 is formed as a wheel element. A resonance circuit with an inductor structure and a capacitor is mounted at its circumference as an inductive coupling element 18 that will be described in more detail in the following.

A stator element 20 that is shown in partial cutaway is formed as a ring element surrounding the rotor element 14. A cylindrical sensor area of the rotation sensor is formed along the circumference of the rotor element 14, where the inductive coupling element 18 and an inductive circuit 20 of the stator element 20 oppose each other with small separation.

FIG. 2 shows the sensor 10 in cross-section, but without the shaft 12. The rotor element 14 is produced as a wheel element made of plastic. This is why the stator element 20 is produced as a ring, also of plastic.

FIGS. 3 and 4 show the rotor element 14 separately. For this, the inductive coupling element 18 is mounted on the sensor areas formed about the circumference.

FIG. 5a and FIG. 5b show this separately. A strip 22 of a flexible carrier material is involved. In this preferred embodiment, the conventional circuit-board material FR4 is used, but at a thickness of only 0.2 mm (shown not to scale in FIG. 5 for the sake of visibility). Conductor strips are mounted on the carrier strip 22 in an inductor structure, whereby a resonance circuit is formed from an inductor structure 24 and a capacitor 26.

For this, the conductor strips are produced using the conventional etching technology used for the manufacture of circuit boards. The capacitor 26 is configured as a SMD-component. The resonance frequency lies preferably in the range of 1-10 MHz, especially preferably between 2 and 6 MHz. In the advantageous embodiment with a component value of the capacitor 26 of 1.5 nF, a resonance frequency of the inductive coupling element 18 of 4 MHz results.

Because of the very low carrier-material thickness of only 0.2 mm, the strip 22 is flexible. It is attached along the sensor area to the rotor element 14 so that the inductive coupling element 18 surrounds the entire circumference of the rotor element 14.

FIGS. 6 and 7 show the stator element 20. This is shaped like a ring element with a sensor area 28 along the ring circumference. An inductive circuit 30 is mounted outside of this sensor area that surrounds the entire circumference. For this, the strip 22 is bent with a radius of about 30 mm.

The inductive circuit 30 is shown separately in FIGS. 8 and 9. This is a flexible carrier strip 32 that in this preferred embodiment is also manufactured of FR4 epoxy material. On the carrier strip is an inductor structure with a receiver coil 34 and two exciter coils 34a, 34b forming a circuit branch and positioned at two opposite corners of a square, with multiple pole connections.

The circuit 30 is formed as a multi-layer (two layers in the illustrated example), double-sided circuit board with penetrating contacts between the layers. The inductor structure thus formed corresponds to the structure of transmitter coils positioned at the corners of a square described in WO-A-03/038379. FIG. 8 does not show this structure exactly, but rather symbolically.

The carrier strip 32 possesses a thickness of only 0.2 mm auf, so that the entire inductive circuit is flexible. Thus, the carrier strip 32 with the diameter required here of about 30 mm may be bent. In the lateral view in FIG. 9, the thickness of the carrier strip 32 is greater for the sake of visibility, and is not to scale. As is further recognizable from the lateral view, there is a section 36 on the end of the inductive circuit 30 onto which components of an evaluation circuit 38 are soldered, and to which the inductors 34, 34a, 34b are connected.

The evaluation circuit 38 controls the exciter coils 34a, 34b as described in WO-A-03/038379 with modulated, phase-displaced signals, and evaluates the signal in the receiver coil 34. For this, the inductors 34, 34a, 34b on the strip 32 are so positioned that no, or only relatively small, over-coupling of the signal from the exciter coils 34a, 34b occurs in the receiver coil 34 without the inductive coupling element 18. Placing the inductive coupling element 18 within the range of the inductive circuit 30 causes position-dependent over-coupling of the exciter coils 34a, 34b in the receiver coil 32, whereby the position of the inductive coupling element 18 may be determined from the phase of the signal in the receiver coil 34.

As FIG. 6 shows, the inductive circuit 30 is mounted onto the outside of the ring-shaped sensor area of the stator 20, whereby the flexible strip 32 is bent ring-shaped across its shorter dimension.

The inductive circuit 30 is mounted on the outside of the sensor area 28 and surrounds the circumference of the ring-shaped stator element 20.

As FIG. 2 shows, in the radially assembled sensor 10, the inductive coupling element 18 and the inductive circuit 30 are opposite each other at a distance. The carrier ring of the stator element 20 is positioned between them so that a small separation results. The electromagnetic field issuing from the inductive circuit 30 penetrates this plastic material and acts on the inductive coupling element. By means of the evaluation circuit 38, the rotational position of the rotor element 14 with respect to the stator element 20 may be determined precisely.

FIG. 10 shows an exploded perspective view of a second preferred embodiment of a sensor 110. While the sensor 10 per the first preferred embodiment was formed purely to determine the rotational position of a shaft 12 with respect to the stator element 20, the sensor 110 per the second preferred embodiment also serves to determine torsion between two shaft components 112a, 112b in addition to determining the rotational position of the shaft components 112a, 112b, or to determine the torque transferred through a shaft 112 formed from the shaft components 112a, 112b.

Rotor elements 114a, 114b are mounted on the shaft components 112a, 112b. As for the first preferred embodiment in connection with FIGS. 3-5, these are formed as wheel elements with a flexible inductive coupling element so that reference may be made to the embodiments there.

The rotor elements 114a, 114b are rotatable within the stator element 120. The stator element 120 is formed as described in connection with the first preferred embodiment with reference to FIGS. 6-9, so that here also reference may be made to the embodiments there.

However, the stator element 120 possesses a greater axial length which is laid out to cover the inductive coupling elements of both rotor elements 114a, 114b. A single inductor structure is positioned above the entire width of the stator element which works together with both coupling elements.

The exploded cutaway view in FIG. 11 shows the design of the sensor 110 with its individual components. The rotor elements 114a, 114b are mounted within the ring-shaped stator element 120 so that the inductive coupling elements and the inductive circuit mounted on the stator element 120 are adjacent and opposite each other, whereby the inductive circuit extends axially to the point that it covers both inductive coupling elements.

A housing 140 with a housing cover 142 is provided for the sensor 110. A plug connector 144 for electrical connection of the evaluation circuit to power supply and signal evaluation is provided at a connection area of the stator element 120, on which the evaluation circuit 38 is mounted as FIG. 6 shows. For this, a plug housing 146 is provided.

FIG. 12 shows the sensor 110 mounted on a shaft 112. For this, the shaft 112 is divided into shaft components 112a, 112b. The shaft components 112a, 112b are coupled together under the influence of a corresponding torsion moment via a torsion element 150 so that they may rotate with respect to each other. For this, rotation is directly connected with the torque transferred by the shaft 112. Instead of a separate torsion element 150, the shaft 112 may also be continuous and include a weakened area so that the shaft components 112a, 112b rotate with respect to each other under the influence of torque.

The housing 140 and the housing cover 142 are fixed, like the stator element 120. The rotor elements 114a, 114b rotate with the shaft components 112a, 112b. During each rotational motion, the inductive coupling elements mounted on the rotor elements 114a, 114b move past the inductive circuit at a distance from the coil structure therein.

For this, the inductive coupling elements are so configured that their coupling behavior is distinguishable. This is achieved in that resonance circuits with different resonance frequencies are formed. For efficient manufacture, as FIG. 5 shows, carrier strips with identical inductor structure are used. However, capacitors with different components are used so that the resonance circuits include resonance frequencies that differ clearly from one another.

The relative position of both inductive coupling elements to the inductive circuit of the stator element 120 may be determined using one and the same inductive circuit. For this, time-displaced loading of the exciter coils is caused by the evaluation circuit 38 first with a signal matched to the resonance frequency of the first inductive coupling element, and then with the resonance frequency of the second inductive coupling element.

The rotational positions of the first and second rotor elements 114a, 114b are thus determined. Depending on the desired output signal at the plug connector 144, the individual rotational positions, or merely one of the two rotational positions may be determined, and/or a differential value between these rotational positions may be determined that represents the torsion of the shaft 112. From this torsion value, the value of transferred torque of the shaft 112 may be determined if the behavior of the torsion element 150 is known under a particular load. In the advantageous preferred embodiment, this calculation is performed in the evaluation circuit 38, and the corresponding value is issued via the plug connector 144.

FIGS. 18-22 show a third preferred embodiment of an inductive sensor. For this, as described for the previously-described second preferred embodiment, a torque sensor with two rotor elements is involved, which are mounted on the two shaft components of a single shaft so that, because of the rotational displacement of the shaft components with respect to each other, the amount of the torque transferred from the shaft may be determined.

FIG. 15-17 show manufacture and assembly of the rotor elements 214. Each of the rotor elements 214 is shaped as a wheel element. A shaft guide bushing 215 of metal provides the connection with the shaft. The guide bushing 215 includes a flange by means of which it is connected with the coupling element holder ring 216, which is made of plastic. For this, the shell guide 215 is created and then inserted into the injection mold in which the holder ring 216 is created. Thus, the shell guide 215 and holder ring 216 are joined via injection molding. Alternatively, the holder ring 216 may be made of plastic as one piece with the shell guide 215.

As in the previously described embodiments, the inductive coupling element 18 is a flexible carrier strip with conductor strips within a flat inductor structure 24 and a discrete SMD capacitor 26 which serves to form a resonance circuit.

The holder ring 216 includes an internal supporting ring 217 with inner support ribs 218 to connect with the shell guide 215. A separation area is formed between the supporting ring 217 and the outer wall of the ring 216 into which the outer ribs extend. The flexible strips of the inductive coupling element 18 are inserted in this area so that the coupling element is positioned between the support ribs 219 and the outer wall. The flexible strip 18 is then mounted as a ring along the circumference of the rotor element 214. In this position, the strip is attached in that the intermediary area is filled with molten plastic during the injection-molding process, and the strip elements 18 are thus embedded.

The rotor element 214 is thus manufactured in a cost-effective manner. As FIG. 17 shows, two rotor elements 214 are required for the torque sensor. With otherwise identical design, they include capacitors of varying values so that the resonance circuit formed on the strips 18 includes varying resonance frequencies.

FIGS. 18-20 show the stator element 220. It consists of a supporting ring element 221 on a circuit-support element 222 that is also made of plastic. The supporting ring element 221 serves to receive the inductive circuit 230. As in the previously described preferred embodiments, the inductive circuit 230 is manufactured as a flexible carrier strip. FR4 epoxy material with a thickness of 0.25 mm is involved, onto which an inductor structure 231 is mounted in two layers with penetrating contacts. For this, a doubled inductor structure is involved in each of which two transmitter coils are arranged at opposite corners of a square in two rings, with one receiver coil each surrounding it. The overall inductor structure formed corresponds to the structure described in WO-A-03/038379, whereby all inductors are present in adjacent pairs.

The ends of the inductors formed on the strips 230 end in contact surfaces 232 at one end of the strip.

The stator element 220 is assembled as shown in FIG. 18. The supporting ring 221 is manufactured in an injection-molding process whereby the inductive circuit 230 is placed into the injection mold, and is thus formed into the supporting ring 221. Alternatively, it is also possible to create the supporting ring 221 with a ring-shaped intermediary cavity, to insert the inductive circuit that has been rolled into a ring into the intermediary cavity, and to attach it suitably. The circuit-support element 222 engages with the supporting ring 221. As necessary, it may be adhered or otherwise affixed using heat shaping.

The inductive circuit 230 extends with its end provided with contact surfaces 232 out of the supporting ring 221, and is guided to the upper side of the circuit-support element 222. A circuit board 234 is positioned there onto which two evaluation circuits 38 are provided as integrated circuits, and other pertinent components, are mounted as a protective circuit. The contact surfaces 232 of the inductive circuit 230 are connected with the configured side of the circuit board 234 so that the inductors formed on it are connected with the integrated circuits 238. The exciter signals are issued to the transmitter coils via these circuits, and they evaluate the signals received in the receiver coils. Like the inductive circuits, the evaluation circuits exist in pairs so that the angular position of two inductive coupling elements may be determined independently. Excitation of the transmitter coils thus occurs on the independently unique resonance frequencies of the associated rotor elements. The stator element thus formed (FIG. 19) is a ring element. It is made of plastic, and is cost-effective yet precise.

As FIG. 21 and FIG. 22 show, the rotor and stator elements 214, 220 are assembled together into a torque sensor on a shaft 12. The rotational position of the two shaft components onto which the rotor elements 214 are mounted are recognized within the evaluation circuits. These rotational positions may be queried at the plug connector 244. The torque in the shaft 12 may be determined from the difference between the rotational positions.

A number of variations to the above-described embodiments is conceivable.

Thus, the flexible carrier strips 22, 32 for the inductive coupling element and the inductive circuit may be manufactured of various materials and using various procedures. The essential concept is that the finished elements are flexible, so that they may be bent into a ring, or at least a partial ring, across its surface. In this manner, a spatial inductor structure may be created especially simply and cheaply.

FIGS. 13 and 14 show an alternative preferred embodiment of a flexible carrier strip 22. For this, an essentially stiff carrier, e.g., an FR4 circuit board with thickness of 1 mm on which a number of slots separated from one another are cut across its shorter dimension, so that the strip-shaped carrier 22 is correspondingly weakened at the slots 210. Although the segments between the slots themselves are stiff, the entire carrier is flexible, and may be bent into a semicircle as shown in FIG. 14.

Various thicknesses of epoxy resin material, e.g., FR4, are used a carrier material. A thickness of 0.2 mm is preferred, but the required flexibility may also be achieved using values of up to 0.5 mm, and preferably up to 0.3 mm. The essential fact is that the carrier strip be so flexible that it may be bent into the necessary diameter. For this, the particular diameter is dependent on the use of the sensor, or, for example, of shaft diameter. Bend radii of 1-10 cm are preferred.

Moreover, other flexible plastic materials may be considered, especially carbon carrier films or Kapton™ films.

One way to mount the inductor structures is by means of the etching process used to produce circuit boards. Other ways include printing or injection processes, or galvanic transfer. To establish the penetrating contacts, conventional drilled holes, laser holes, or other techniques are used.

Manufacture of the flexible elements may also result by means of wires that are adhered to the film or laminated between layers.

What is claimed is:

1. An inductive torque sensor comprising:
a stater element having a sensor area;
at least two axially adjacent and spaced apart rotor elements that are co-axially mounted with respect to the stator element on co-axial components of a shaft, the rotor elements being rotatable with respect to the stator element;
an inductive coupling element disposed around the circumference of each rotor element; and
an inductive circuit with at least two inductors disposed along the sensor area of the stator element, such that when the rotor elements rotate, the inductive coupling elements move along with the inductors and cause a position-dependent inductive coupling between the inductors;
wherein the inductive circuit is so positioned that it overlaps the inductive coupling elements of both rotor elements; and
wherein the inductive coupling elements possess differing inductive coupling characteristics.

2. Sensor as defined in claim 1, wherein the inductive circuit includes a flexible carrier material on which the inductors are formed, and wherein the flexible carrier material is bent and extends along the sensor area.

3. Sensor as defined in claim 2, wherein the flexible carrier material is bent into at least a partially ring-shaped form.

4. Sensor as defined in claim 2, wherein the flexible carrier material is embedded in plastic material.

5. Sensor as defined in claim 1, wherein each of the inductive coupling elements includes inductors that are formed on a flexible carrier material conductors, whereby the flexible carrier material is bent and extends along the sensor area.

6. Sensor as defined in claim 5, wherein the flexible carrier material is bent into at least a partially ring-shaped form.

7. Sensor as defined in claim 5, wherein the flexible carrier material is embedded in plastic material.

8. Sensor as defined in claim 1, wherein the inductive circuit includes two spatially separated inductor structures, each possessing at least one transmitter coil and one receiver coil, and wherein the inductor structures form axially-adjacent rings, and each ring is covered by a coupling element.

9. Sensor as defined in claim 1, wherein the stator element is ring-shaped, and the rotor elements are also ring-shaped and positioned within the ring formed by the stator element.

10. Sensor as defined in claim 1, wherein each of the rotor elements is mounted on flying shaft components, and wherein the shaft components are connected together elastically so that they may be rotated against each other.

11. Sensor as defined in claim 1, wherein an evaluation circuit is provided on the stator element connected to the inductive circuit that creates an exciter signal in at least one of the inductors and receives and evaluates a receiver signal from at least one additional coil, and wherein the evaluation circuit determines a value from the receiver signal for the rotational position of at least one of the rotor elements.

12. Sensor as defined in claim 11, wherein the rotational position of the first and of the second rotor-elements is determined in the evaluation circuit, and wherein a value for the torque is calculated from the differential in rotational positions.

13. Sensor as defined in claim 11, wherein a plug connector is provided on the stator element for the evaluation circuit.

14. Sensor as defined in claim 1, wherein the inductive coupling element is configured as a resonance circuit with a capacitor and with an inductor.

15. A rotation sensor comprising:
a stator element;
at least one rotor element rotatable about a rotation axis, co-axial with the stator element;
an inductive coupling element disposed on the rotor element; and
an inductive circuit with at least two inductors disposed on the stator element that extends along a sensor area so that, when the rotor and rotator elements rotate with respect to each other, the inductive coupling element is displaced along the inductors and causes a position-dependent inductive coupling between the inductors;
wherein the inductive circuit includes a flexible carrier material on which the inductors are formed as conductors; and
wherein the flexible carrier material is bent and extends along the sensor area.

16. Sensor as defined in claim 15, further comprising:
two rotatable rotor elements that are positioned opposite the stator element to be rotatable about a common rotation axis;
wherein each of the rotor elements includes an inductive coupling element; and
wherein the inductive coupling elements possess differing inductive coupling characteristics.

17. Sensor as defined in claim 15, wherein the stator element is a fixed ring element that is at least partially radially positioned about the rotor element, and wherein the sensor areas are at least partially cylindrical surfaces.

18. Sensor as defined in claim 15, wherein the stator element includes a receiver area to receive the flexible carrier material.

19. Sensor as defined in claim 15, wherein an evaluation circuit is provided on the stator element connected to the inductor circuit that creates an excitation signal in at least one of the inductors and receives and evaluates a receiver signal from at least one additional coil; and wherein the evaluation circuit determines the value for the rotational position of at least one rotor element from the receiver signal.

20. Sensor as defined in claim 19, wherein the evaluation circuit determines a value for the rotational position of the first and of the second rotor elements from the receiver signal.

21. Sensor as defined in claim 19, wherein a plug connector is provided on the stator element for the evaluation circuit.

22. Sensor as defined in claim 15, wherein a housing is provided that substantially surrounds the first and second elements.

23. Sensor as defined in claim 15, wherein the inductive coupling element is formed as a resonance circuit with a capacitor and an inductor.

24. Sensor as defined in claim 15, wherein the coupling element includes a flat conductor structure that is mounted on flexible carrier material, and wherein the flexible carrier material is bent and extends along the rotor element. on flexible carrier material, and wherein the flexible carrier material is crimped about the rotor element.
